(19) United States
(12) Patent Application Publication
(10) Pub. No.: US 2023/0103237 A1
(43) Pub. Date: Mar. 30, 2023

(54) BIODEGRADABLE PARTICLES AND BIODEGRADABLE PARTICLES IN CONTACT WITH ACTIVE INGREDIENTS

(71) Applicant: The United States of America, as represented by the Secretary of Agriculture, Washington, DC (US)

(72) Inventors: AMIE E. NORTON, MANHATTAN, KS (US); LEE W. COHNSTAEDT, MANHATTAN, KS (US); ROBERT D. EWING, WAMEGO, KS (US); MICHAEL TILLEY, MANHATTAN, KS (US); SCOTT R. BEAN, MANHATTAN, KS (US)

(21) Appl. No.: 17/954,632

(22) Filed: Sep. 28, 2022

Related U.S. Application Data
(60) Provisional application No. 63/249,747, filed on Sep. 29, 2021.

(51) Int. Cl. A01N 25/00; A01N 25/26; A01N 59/16; A01P 7/04

(52) U.S. Cl. CPC A01N 25/006; A01N 25/26; A01N 59/16; A01P 7/04

(57) ABSTRACT

The invention relates to biodegradable particles and compositions comprising biodegradable particles comprising at least one active ingredient. At least one active ingredient may be inside, throughout, or outside of the biodegradable particle. The at least one active ingredient may be at least one of a pesticide, a dye, an arthropod attractant, an arthropod repellent, an arthropod nutrition supplement, an enhancer of arthropod pest resistance, an enhancer of plant arthropod resistance, an enhancer of plant sprouting and development, a food supplement for mammal consumption, or a combination thereof. The invention further relates to methods for preparing such biodegradable microparticles and compositions, methods of using such biodegradable microparticles and compositions, and kits comprising such biodegradable microparticles and compositions.

### CROSS-REFERENCE TO RELATED APPLICATIONS

This application claims priority to U.S. Provisional Patent Application No. 63,249,747, filed Sep. 29, 2021. The content of this provisional patent application is hereby expressly incorporated by reference in its entirety.

### Field of the Invention

The invention relates to biodegradable particles, and to compositions comprising such biodegradable particles in contact with at least one active ingredient for the control of arthropods, arthropod pests, and/or as an arthropod, mammal, or plant nutritional supplement.

### Background of the Invention

Mosquitos transmit pathogens, which may result in diseases such as malaria, West Nile, Zika, chikungunya, and dengue fever. The use of chemical pesticides to reduce mosquito populations may have many undesirable side effects such as toxicity to non-target organisms, to the environment, and to humans.

Particles may play an important role in targeted pesticide development, and are used for drug delivery, tissue engineering applications, and for their antimicrobial activities. Current methods to synthesize nanoparticles require chemical and physical methods that involve high pressure, energy, temperature, and toxic chemicals. Plant extracts are an attractive alternative to decrease solvent volume, energy consumption, and toxic chemicals. More specifically, the use of agricultural products such as cereal grain fractions in the preparation of biodegradable particles can help fill the need for biofriendly materials.

Silver nanoparticles have been shown to be effective antimicrobial agents, and to kill E. coli cells. Mosquito larvae need bacteria in their gut to grow and survive. Due to the importance of bacteria for mosquito survival, silver nanoparticles can play an important role as pesticides.

Many grain pests preferentially eat the grain embryos lowering the percentage of seeds that germinate. Thus, protecting seeds from arthropod consumption will ensure more seeds germinate.

Thus, new methods of preparing biodegradable particles and biodegradable particles in contact with active ingredients to control mosquitoes and other arthropods, as well as aiding in seed sprouting and seedling development are needed.

### SUMMARY OF THE INVENTION

Provided herein are compositions comprising a biodegradable particle and compositions comprising such biodegradable particle in contact with at least one active ingredient. The compositions may be used at least to attract, feed, repel, kill, or stunt development of arthropods, or to enhance seedling nutrition and/or pest resistance.

In an embodiment, the invention relates to a biodegradable particle. In some embodiments of the invention, the biodegradable particle is in contact with at least one active ingredient, and optionally comprises a protective coating. In some embodiments of the invention, the biodegradable particle is a natural food source for a target arthropod and/or a target plant. In some embodiments of the invention the natural food source for a target arthropod and/or a target plant is a solid or a liquid.

In an embodiment, the invention relates to a method for preparing biodegradable particles. In some embodiments the invention relates to a method for preparing a biodegradable particle in contact with an active ingredient.

In an embodiment, the invention relates to a kit comprising a biodegradable particle. In some embodiments the invention relates to a kit comprising a biodegradable particle in contact with an active ingredient, and optionally a coating.

### BRIEF DESCRIPTION OF THE DRAWINGS

FIG. 1A and FIG. 1B depict images of zein particles obtained by transmission electron microscopy. The image on FIG. 1A is of a zein particle. The line in the image depicts 200 nm. The image on FIG. 1B is of a zein particle treated with silver (a zein-silver particle). The line in the image depicts 100 nm. Dark arrows show a silver particle, light grey arrows show surface of a zein particle.

FIG. 2A and FIG. 2B depict graphs of the Dynamic Light Scattering (DLS) intensity obtained to measure particle sizes. FIG. 2A shows the DLS obtained for zein particles. FIG. 2B shows the DLS obtained for zein-silver particles. The Y axis presents the measured intensity. The X axis presents the diameter size in nanometers (nm). The instrument takes three measurements on the same sample.

FIG. 3 depicts a graph of the UV-visible spectrum of zein-silver particles. The Y axis presents the absorbance. The X axis presents the wavelength.

FIG. 4 depicts a graph of the FTIR spectrum of zein particles and zein-silver particles. The Y axis presents the intensity. The X axis presents the wavenumber per centimeter (wavenumber cm⁻¹).

FIG. 5 depicts a graph of the percentage of mosquito larvae death as a function of time for the different zein-silver particle solutions. This graph includes the results from five (5) trials with twenty (20) 3^{rd} instar or 4^{th} instar larvae. The Y axis presents the percentage death (Lethal %). The X axis presents the time after treatment in hours. Circles represent 100 ppm zein-silver particles; triangles represent 1 ppm zein-silver particles; diamonds represent 0.1 ppm zein-silver particles.

FIG. 6A and FIG. 6B depict images of mosquito larvae not exposed and exposed to 100 ppm zein-silver particles. FIG. 6A shows an image of a control, not treated mosquito (Live), and a mosquito dead due to exposure to 100 ppm zein-silver particles (Dead). FIG. 6B shows an image of a mosquito dead due to exposure to 100 ppm zein-silver particles. Bars in the images represent 100.00 μm.

FIG. 7A and FIG. 7B depict images of abdomens from mosquito larvae. FIG. 7A shows an image of the abdomen of a mosquito exposed to water. FIG. 7B shows an image of the abdomen of a mosquito exposed to 100 ppm zein-silver particles.

FIG. 8 depicts a TEM image of a transverse tissue of a mosquito exposed to 1 ppm zein-silver particles. Box indicates silver particle. Bar in the image indicates 500 nm.

FIG. 9 depicts a graph of the FTIR spectra of a mosquito exposed to water and a mosquito exposed to zein-silver particles. The Y axis presents the % Transmittance. The X axis presents the wavenumbers in centimeters (cm).

### DETAILED DESCRIPTION

Provided herein are biodegradable particles and compositions comprising a biodegradable particle in contact with at least one active ingredient. The at least one active ingredient may be inside or outside of the biodegradable particle, and may be at least one of a pesticide, a dye, an arthropod attractant, an arthropod repellent, an arthropod or plant nutrition supplement, an enhancer of insect pest resistance, or an enhancer of plant pest resistance. Provided herein are also methods for preparing such biodegradable particles and compositions, methods of using such biodegradable particles and compositions, and kits comprising such biodegradable particles and compositions.

In some embodiments of the invention, the biodegradable particle in a composition of the invention comprises a natural food source for a target arthropod and/or a target plant, or a food supplement for a mammal. In some embodiments of the invention, the biodegradable particle that comprises a natural food source for a target arthropod and/or a target plant is derived from a grain. In some embodiments of the invention, the biodegradable particle is from a grain such as wheat, oat, rice, corn, buckwheat, bulgur, sorghum, millet, coffee, soybean, alfalfa, rye, triticale, quinoa, amaranth, or barley. In some embodiments of the invention, the biodegradable particle is a natural food source for a target insect, and is corn zein, wheat starch, wheat gluten, wheat bran, sorghum starch, sorghum gluten, sorghum bran, sorghum high phenolic bran, or sorghum kafirin. In some embodiments of the invention, the mammal is a companion animal or a human.

Arthropods are invertebrate animals having an exoskeleton, a segmented body, and paired jointed appendages. An arthropod may be, for example, an insect, a spider, a mite, a tick, a scorpion, a daddy-long-legs, a millipede, a pill bug, or a crustacean. Insects are the largest group within the arthropod phylum. Insects are invertebrates and have a chitinous exoskeleton, a three-part body, three pairs of jointed legs, compound eyes, one or two pairs of wings, and one pair of antennae. Examples of insects are ants, bees, wasps, beetles, weevils, butterflies, moths, caddisflies, cockroaches, crickets, grasshoppers, katydids, diplurans, dragonflies, damselflies, earwigs, fleas, flies, gladiator bugs, hemipterans, homopterans, ice bugs, lacewings, lice, mantids, mayflies, megalopterans, psocids, scorpionflies, stoneflies, sptrepsipterous, termites, thrips, true bugs, walkingsticks, webspinners, and apterygote.

Some insects provide services to mankind and the environment. For example, insects keep pest insects in check, pollinate crops humans rely on as food, and act as sanitation experts, cleaning up waste so that the world doesn't become overrun with dung or decay matter. Some insects are considered pests because they transmit diseases to humans, or eat/damage crop plants. Examples of pest insects are mosquitoes, aphids, beetles, broad mites, etc. Vegetable and field crop pest insects are, for example, aphid, armyworm, cabbage maggot, carrot rust fly, Colorado potato beetle, corn earworm, cucumber beetle, cutworm, diamondback moth, European earwig, flea beetle, garden symphylan, grasshopper, imported cabbageworm, leafhopper, looper, lygus bug, seedcorn maggot, slug, spider mite, squash bug, thrips, western bean cutworm, whitefly, and wireworm.

When in contact with at least one active ingredient, the novel biodegradable particles of the invention may function as a long-lasting larvicide or adulticide for arthropod pests such as mosquitoes, flies, ticks, cockroaches, termites, mites, beetles, or moths of medical, veterinary, stored product, or field crop importance. In an embodiment, the invention relates to a composition comprising a biodegradable particle, at least one active ingredient in contact with the biodegradable particle, and optionally comprising a protecting coating.

In an embodiment of the invention, the active ingredient in contact with the biodegradable particle is inside the particle, dispersed throughout the particle, or coating the particle.

In an embodiment of the invention, the active ingredient is a metallic particle. In some embodiments of the invention, the metallic particle is a silver, gold, copper, iron, magnesium, cobalt, zinc, nickel, or tin nanoparticle. In an embodiment of the invention, the active ingredient is a bioactive or naturally-occurring compound. In some embodiments of the invention the active ingredient may be curcumin, acetic acid, Methoprene, Spinosad, or Bacillus thuringiensis subspecies Israelensis (BTI). In an embodiment of the invention, the active ingredient a supplement, trehalose, or proline.

In an embodiment, the invention relates to biodegradable particles in contact with an active ingredient, and surrounded by a protective coating. In some embodiments of the invention the protective coating surrounding a biodegradable particle in contact with an active ingredient is a polymer, a hydrogel, a surfactant, or a reactive coating. In some embodiments of the invention the reactive coating surrounding a biodegradable particle in contact with an active ingredient is a temperature-sensitive coating, a pH-responsive coating, or a UV-visible responsive coating.

In an embodiment, the invention relates to a method for preparing a biodegradable particle. In some embodiments of the invention, the method for preparing a biodegradable particle comprises mixing equal amounts of lactic acid, polyethylene, and glycerol, and adding to glacial acetic acid to prepare a mixture. Adding to the mixture a grain such as wheat, oat, rice, corn, buckwheat, bulgur, sorghum, millet, coffee, soybean, alfalfa, rye, triticale, quinoa, amaranth, or barley, followed by heating and stirring until the grain is dissolved, to create a biodegradable particle.

In some embodiments of the invention, an active ingredient is added to the biodegradable particle. Addition of the active ingredient to the biodegradable particle may be performed by mixing a metal with the biodegradable particle, and heating to create particles of the active ingredient in the biodegradable particle. In some embodiments of the invention, sodium borohydride is added to the mixture of the metal with the biodegradable particle. Addition of active ingredients to the biodegradable particles in this manner allows for metallic particles to be in contact with food, or be used in food packaging without contaminating the food product. In some embodiments of the invention, addition of silver or gold as active ingredients was done by adding (0.090 grams of active ingredient) to 500 mL of H₂O. In a separate container, 0.1 grams of biodegradable particles were suspended in 15 mL H₂O. The biodegradable particle solution was slowly added to the 500 mL of H₂O containing the metal, while the solution was heated to 37° C. After the addition and dissolution of the particles into the water, 1M sodium borohydride solution was added dropwise (0.1 mL) to the solution until the solution turned brown/purple (brown when using silver, and purple when using gold). In some embodiments of the invention, the metallic particles were synthesized in the absence of borohydride. To do this, 10 mL of phenolic extract in 70% ethanol was added to 10 mL of water, and 2 mL of 0.1 M AgNO₃ was added. Large particles started to precipitate; small particles remained in solution. The solution was decanted, and 50 mL of water were added. The solution was then filtered through a 0.22 μm FLIPCUP filter. Another method used to form metallic particles on biodegradable particles was to place sorghum Phenolic or flour extract in water (10 mL) in a petri dish, and 5 mL of 0.1 M of gold was added to the solution. The solution was diluted to 40 mL with water, followed by mixing. The solution was then placed under a UV-visible light (5 mW, 405 nm) for 4 hours. Gold particles formed in 2 hours, the reaction continued for 2 more hours.

In an embodiment, the invention relates to a method for causing mortality or developmental stunting of an arthropod by contacting the arthropod with a composition of the invention. In some embodiments of the invention, the method causes mortality or developmental stunting of a mosquito, a mosquito larva, a house fly, an ant, a biting midge, a bee, a red flour beetle, or other common pest of medical, veterinary, agricultural, or urban importance.

As shown in the examples, the mosquito lethal dose obtained using a biodegradable particle in contact with silver as an active ingredient was lower than any lethal dose reported in the literature to date. Preparation of 20 mL of a suspension of biodegradable particles in contact with silver as an active ingredient, where the silver is present at about 1 ppm, as taught in the examples, cost approximately $0.002. Use of biodegradable particles as delivery vehicles allows for fine control of the amount of active ingredient to be delivered. Preparation and use of the biodegradable particles of the invention are novel processes that can be used with food products at a minimal cost, and which allow for adjustable concentrations of active ingredient (AI) per particle, lower concentration of particles per lethal dose, and controlled delivery in a consumable particle.

In an embodiment, the active ingredient in contact with the biodegradable particle of the invention may be proline, trehalose, or any diet supplement for bees, mosquitoes, or other arthropod. Other bee supplements that may be used as active ingredients with the biodegradable particles of the invention are honey, peanut oil, and soybean oil.

In an embodiment, the invention relates to a composition comprising a biodegradable particle that is a plant nutrient particle and is a natural food source for a target plant, such that the plant will take the biodegradable particle from the environment as it would normally take a nutrient.

In some embodiments of the invention, a composition of the invention may further comprise at least one additional chemical that is useful for reducing plants or reducing pests. In some embodiments of the invention, the composition comprising at least one biodegradable particle further comprises at least one of a fungicide, an herbicide, a pesticide, a nematicide, an insecticide, a plant activator, a synergist, an herbicide safener, a plant growth regulator, an insect repellant, an acaricide, a molluscicide, or a fertilizer. In some embodiments of the invention, the composition comprising at least one biodegradable particle may further comprise a surfactant. In some embodiments of the invention, the composition comprising at least one biodegradable particle further comprises a carrier.

In an embodiment, the invention relates to a kit comprising at least one biodegradable particle as disclosed herein. In some embodiments of the invention, the biodegradable particle in the kit of the invention is a liquid or a solid. In some embodiments of the invention the biodegradable particle in the kit is derived from a grain such as wheat, oat, rice, corn, buckwheat, bulgur, sorghum, millet, coffee, soybean, alfalfa, rye, triticale, quinoa, amaranth, or barley. In some embodiments of the invention, the biodegradable particle is a natural food source for a target arthropod, and is corn zein, wheat starch, wheat gluten, wheat bran, sorghum starch, sorghum gluten, sorghum bran, sorghum high phenolic bran, or sorghum kafirin.

In some embodiments of the invention, the kit comprises at least one biodegradable particle in contact with an active ingredient. In some embodiments of the invention, the active ingredient in contact with the biodegradable particle may be at least one of a pesticide, a dye, an insect attractant, an insect repellent, an insect nutrition supplement, an enhancer of insect pesticide resistance, a plant fertilizer, or an enhancer of plant insect resistance. In an embodiment of the invention, the active ingredient in contact with the biodegradable particle of the invention is a metallic particle. In some embodiments of the invention, the metallic particle in contact with a biodegradable particle of the invention is derived from silver, gold, copper, iron, magnesium, cobalt, zinc, nickel, or tin. In an embodiment of the invention, the active ingredient in contact with a biodegradable particle of the invention is a bioactive compound. In some embodiments of the invention, the active compound in contact with a biodegradable particle of the invention is curcumin, acetic acid, Methoprene, Spinosad, or Bacillus thuringiensis subspecies Israelensis (BTI). In an embodiment, the active ingredient in contact with a biodegradable particle of the invention is trehalose or proline.

In an embodiment of the invention, the kit comprising a biodegradable particle or a biodegradable particle in contact with at least one active ingredient may comprise one or more containers. In some embodiments of the invention, the biodegradable particle or the biodegradable particle in contact with at least one active ingredient may in the same container as at least one carrier, adjuvant, auxiliary, or extender. In some embodiments, the composition comprising a biodegradable particle may be in one container and the at least one carrier, adjuvant, auxiliary, or extender may be in at least one different container. In some embodiments of the invention, kit may comprise one or more containers with one or more compartments. In some embodiments of the invention, the composition comprising at least one biodegradable particle may be in a first compartment, and the at least one carrier, adjuvant, auxiliary, or extender may be in at least one second compartment of the same container.

In an embodiment, the invention provides a method for promoting plant or plant part germination/sprouting. The method comprising the step of contacting a plant or plant part with a sufficient amount of a composition comprising at least one biodegradable particle to promote germination/sprouting compared to the germination/sprouting of a plant or plant part not contacted with the composition. In some embodiments of the invention, the plant or plant part treated with a composition comprising at least one biodegradable particle of the invention is a monocotyledon. In some embodiments of the invention, the plant or plant part treated with a composition comprising at least one biodegradable particle is a dicotyledon.

A composition comprising at least one biodegradable particle of the invention can be applied to plants or plant parts using at least one of a variety of methods known in the art. The composition comprising at least one biodegradable particle of the invention may be applied to the target plant or plant part using a variety of conventional methods such as dusting, coating, injecting, rubbing, rolling, dipping, spraying, or brushing, or any other appropriate technique which does not significantly injure the target plant or plant part to be treated. Methods of applying the composition comprising at least one biodegradable particle of the invention to plants or plant parts may be, e.g., by spraying, atomizing, dipping, pouring, irrigating, dusting, or scattering the compositions over the propagation material, or by brushing or pouring the composition over the plant or plant part. When the plant part is a seed, application may be done, for example, by injecting, coating, encapsulating, atomizing, spraying, dipping, or immersing the seed in a liquid composition comprising a biodegradable particle, or otherwise treating the seed. When the plant part is a fruit, application of a composition comprising at least one biodegradable particle may be done by dusting, coating, injecting, rubbing, rolling, dipping, spraying, or brushing, or any other appropriate technique which does not significantly injure the fruit. In an alternative, the compositions comprising at least one biodegradable particle can be introduced into the soil by spraying, scattering, pouring, irrigating, or otherwise treating the soil.

Compositions comprising a biodegradable particle of the invention may be in any customary form suitable for application, such as solutions, emulsions, wettable powders, water-based suspensions, oil-based suspensions, powders, dusts, pastes, soluble powders, soluble granules, granules for broadcasting, suspension-emulsion concentrates, natural materials impregnated with active compound, synthetic materials impregnated with active compound, fertilizers, or microencapsulation in polymeric substances. The biodegradable particles of the invention may be used in compositions produced in a known manner, for example by mixing biodegradable particles with suitable adjuvants, extenders, and/or surfactants. Extenders may be liquid solvents and/or solid carriers. Surfactants may be emulsifiers and/or dispersants and/or foam-formers. The compositions may be prepared ahead of time, immediately before application, or during application.

The biodegradable particles of the invention may be used in conjunction with an adjuvant, which aids absorption of the compound into the desired arthropod, seed, and/or plant.

As used herein, a “nanoparticle” ranges in size from about 1 nm to about 100 nm, a “microparticle” ranges in size from about 100 nm to about 100,000 nm (0.1-100 μm), and a “milliparticle” ranges in size from about 100,000 nm to about 1,000,000,000 nm (1 mm to 1 m). The particle size can vary depending on the application of the particle technology. For example, treatments to plants that are absorbed by the plant must be small enough to enter the roots or leaves (nanoparticles) whereas treatments to insects eating the plants must be foraged by the insect or target pest and therefore be visible (milliparticles). In contrast, the filter feeding mouth parts of larval mosquitoes strain particles out of the water column and therefore the particles must be small enough to float (microparticles), but not too small that they pass through the brush like filters of the insects as they collect food.

As used herein, “a reduction” or “control” of a population of arthropods in an environment having a composition comprising a biodegradable particle of the invention means that the level of arthropods is reduced relative to the number arthropods in a population in an environment lacking a composition of the invention. In some aspects of the invention, a reduction in arthropods may occur due to the reduction in fitness of the arthropod population, or to the death or incapacitation of an arthropod population, or due to the exit of members of the population from an environment containing a composition of the invention.

As used herein, the term “at least a partial reduction” of a population of arthropods in an environment having a compound of the invention means that the population level is reduced by at least 25% relative to the number of arthropods in a population in an environment lacking a composition of the invention. Also as used herein, it is understood that in environments having multiple populations of arthropods, each population may be “partially reduced” independently.

As used herein, the term “a substantial reduction” of a population of arthropods in an environment having a composition of the invention means that the population level is reduced by at least 75% relative to the number of arthropods in a population in an environment lacking a composition of the invention. Also as used herein, it is understood that in environments having multiple populations of arthropods, each population may be “substantially reduced” independently.

As used herein, the term “an effective elimination” of a population of arthropods in an environment having a composition of the invention means that the population level is reduced by greater than 95% relative to the number of organisms of a population in an environment lacking a composition of the invention. Also as used herein, it is understood that in environments having multiple populations of arthropods, each population may be “effectively eliminated” independently. An effective amount of a composition of the invention is preferably capable of providing at least a partial reduction, more preferably a substantial reduction, or most preferably effective elimination of an arthropod population.

As used herein, the terms “suppress,” “repress,” and “downregulate” are used equivalently herein when referring to a population of arthropods, and mean that the levels of a population of arthropods are reduced relative to the number of arthropods in a population that would occur in the absence of a composition of the invention under similar or identical conditions.

As used herein, the terms “control,” “controls,” or “controlling” a population of arthropods by providing a composition of the invention to the arthropod for a period of time refers to either killing of the arthropod, inducing a behavioral change in the arthropod, or both, that results in reduction of the population of the arthropod in a composition of the invention environment relative to an untreated environment. Different levels of a composition of the invention may have different effects on arthropod populations, and may require different periods of exposure to the composition of the invention to accomplish desired levels of reduction.

As used herein, the term “an arthropod” or “at least one arthropod” may include a plurality of arthropods, including mixtures thereof.

As used herein, the term “grain” refers to a harvested edible seed of a plant.

As used herein, the term “about” is defined as plus or minus ten percent of a recited value. For example, about 1.0 g means 0.9 g to 1.1 g.

As used herein, the term “mock-treated” means that the arthropod, seed, or plant has been treated with buffer in the absence of at least one biodegradable particle or at least one biodegradable particle in contact with an active ingredient.

As used herein, the term “treatment control” refers to an arthropod, seed, or plant that is not treated with a composition of the invention or with a buffer, but is analyzed at the same time as an arthropod seed, or plant that is treated with a composition of the invention or with a buffer.

As used herein, the term “exposing” means generally bringing into contact with at least one biodegradable particle or one biodegradable particle comprising at least one active ingredient. Exposure may be direct or indirect. Exposure of an arthropod, seed, or plant to a compound of the invention includes administration of the compound to the arthropod, seed, or plant, otherwise bringing the arthropod, seed, or plant into contact with the compound itself. Contacting with the compound may be done by spraying, immersing, injecting an area the arthropod, seed, or plant; or by contacting with the compound a surface or solution in which the arthropod, seed, or plant is present. In the present disclosure, the terms “exposing,” “administering,” “contacting,” and variations thereof may, in some contexts, be used interchangeably.

As used herein, the term “sufficient amount” denotes an amount of a composition comprising at least one biodegradable particle alone or in contact with an active ingredient sufficient to promote reduction of an arthropod population, improve a bee's pest resistance, promote seed germination and sprouting, and/or enhance plant insect resistance. Such amount can vary in a broad range and is dependent on various factors such as the arthropod, seed, bee, or plant exposed, the climate, the weather, and/or soil conditions, and the specific biodegradable particle and active ingredient in the composition.

As used herein, it is intended that reference to a range of numbers (for example, 1 to 10) also incorporates reference to all rational numbers within that range (for example, 1, 1.1, 2, 3, 3.9, 4, 5, 6, 6.5, 7, 8, 9 and 10) and any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

As used herein, the term “carrier” includes a natural or synthetic, organic or inorganic solid or liquid substance with which an active compound is mixed or bonded, for example to provide better applicability, in particular for application to plants or parts of plants. The carrier, which may be solid or liquid, is generally inert and should be suitable for use in agriculture.

As used herein, the term “adjuvant” includes an agent that modifies the effect of the active compound for use in the present invention. An adjuvant may be an auxiliary. Suitable auxiliaries for use in the present invention include substances that are suitable for imparting to the composition itself and/or to preparations derived therefrom (for example spray liquors, seed dressings) particular properties such as certain technical properties and/or also particular biological properties. Typical suitable auxiliaries are extenders, solvents and carriers.

Unless otherwise explained, all technical and scientific terms used herein have the same meaning as commonly understood by one of ordinary skill in the art to which this disclosure belongs. The singular terms “a”, “an”, and “the” include plural referents unless context clearly indicates otherwise. Similarly, the word “or” is intended to include “and” unless the context clearly indicate otherwise.

Embodiments of the present invention are shown and described herein. It will be obvious to those skilled in the art that such embodiments are provided by way of example only. Numerous variations, changes, and substitutions will occur to those skilled in the art without departing from the invention. Various alternatives to the embodiments of the invention described herein may be employed in practicing the invention. It is intended that the included claims define the scope of the invention and that methods and structures within the scope of these claims and their equivalents are covered thereby. All publications, patents, and patent applications mentioned in this specification are herein incorporated by reference to the same extent as if each individual publication, patent, or patent application was specifically and individually indicated to be incorporated by reference.

### EXAMPLES

Having now generally described this invention, the same will be better understood by reference to certain specific examples, which are included herein only to further illustrate the invention and are not intended to limit the scope of the invention as defined by the claims.

### Example 1

### Zein Particle and Zein-Silver Particle Preparation and Characterization

Silver particles were prepared in the presence of the zein particles.

Zein micro particles were synthesized following Taylor et al. (2009, “Formation of Kafirin Microparticles by Phase Separation from an Organic Acid and Their Characterisation,” J. Cereal Sci. 50(1): 99-105). Briefly, 0.66 grams each of lactic acid, polyethylene, (6000 MW), and glycerol were added to 4.34 mL of glacial acidic acid, followed by stirring in 1.8 grams of zein. The temperature was slowly raised to 37° C., and the solution was stirred until everything was dissolved. The solution was then removed from heat, and water was added dropwise until the solution reached the volume of 70 mL. The solution was then allowed to stir for 5 more minutes. The solution was then centrifuged, and the supernatant was poured off. The particles were washed 3 times with 20 mL of water.

Silver particles were synthesized following Suganya, P., et al. (2017, “Biopolymer zein-coated gold nanoparticles: Synthesis, antibacterial potential, toxicity and histopathological effects against the Zika virus vector Aedes aegypti,” J. Photochem. Photobiol. B 173: 404-411), with slight modifications. To 500 mL of H₂O 0.090 grams of silver nitrate were added. In a separate container 0.1 grams of zein particles prepared as above were stirred in 15 mL of H₂O. The zein-particle solution was slowly added to the 500 mL of H₂O, while the solution was heated to 37° C., followed by the addition of sodium borohydride to a total of 0.2 ppm, when the solution turned brown.

The zein particles and zein-silver particles were characterized by transmission electron microscopy (TEM), ultraviolet-visible (UV-Visible) spectrum, and dynamic light scattering (DLS). For SEM, the samples were fixed in 4% formaldehyde and 1% glutaraldehyde fixative overnight, washed in phosphate buffer, dehydrated through a graded ethanol series, followed by drying in a SAMDRI 790 B critical point dryer (Tousimis; Rockville, Md., USA). Dried samples were placed on double sided conductive carbon sticky tape coated aluminum stub, sputtered with palladium using a Denton Vacuum Desk II sputter coater (Denton Vacuum; Moorestown, N.J., USA). Samples were analyzed under a HITACHI S-3500N Scanning Electron Microscope (Hitachi Science Systems Ltd.; Tokyo, Japan) at accelerating voltage of 15 kV. Presence of silver was confirmed by an energy dispersive X-ray spectroscopy (EDS) using an OXFORD EDS detector (Oxford Instruments Microanalysis Group; High Wycombe, England).

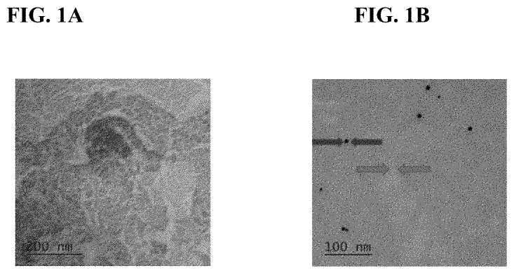

To characterize the particles by TEM, a drop of 0.01 M solution was placed on a carbon coated 200 mesh copper grid, and the grid was allowed to dry for 60 minutes. The grids were viewed at an accelerating voltage of 120 kV on a FEI TECNAI G2 Spirit BIOTWIN transmission electron microscope. Optical images were recorded on a Keyence VHX-6000 digital microscope. As seen in FIG. 1A, the TEM images of the zein particles showed a surface that looked porous. FIG. 1B shows that silver particles formed on the surface of the zein particles. The particles size was measured using DLS.

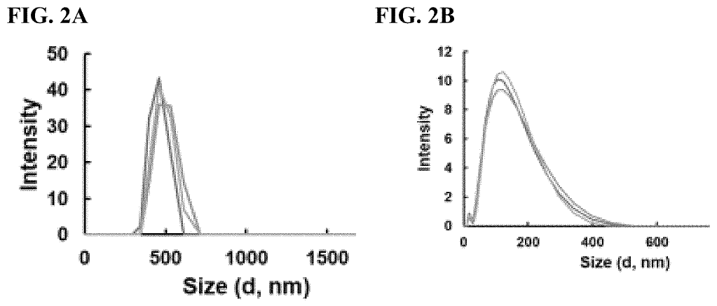

DLS was conducted on a Malvern Zetasizer. FTIR-ATR using a Thermo Scientific 50 Nicolet equipped with OMINIC spectra software. As seen on FIG. 2A and FIG. 2B, the zein particles measured approximately 500 nm in diameter, and the zein-silver particles measured approximately 100 nm in diameter. The 500 nm size of the zein particles is larger than what has been reported previously. Not wishing to be bound by theory, one reason for this discrepancy may be the ability of the zein particles to aggregate. It is also possible that the zein particles appear larger because they were prepared using a modified procedure from what has been published. The shape and size of the silver particles were in line with what has been reported in literature. The silver particles on the surface of the zein particle were about 15 nm in diameter.

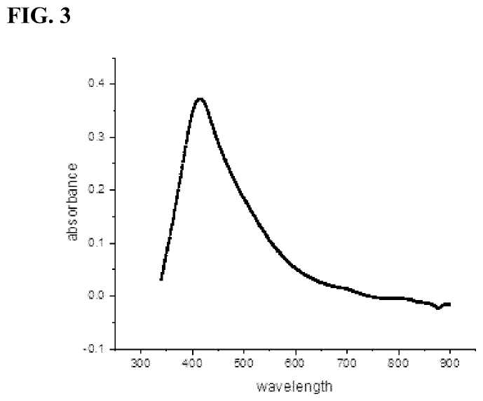

UV-Visible measurements were conducted using a Biotek Epoch 2 micro plate reader spectrometer, and recorded to further characterize the particles. As seen in FIG. 3, the Zein particles were UV-visible inactive, which is in agreement with the literature, while the zein-silver particles showed a maximum of 400 nm and a full-width-half-maximum (FWHM) of 5641 cm-1. The 400 nm UV-Visible maximum is in good agreement with the current literature for silver nanoparticles. This UV-visible maximum was used to predict the silver particle size using a method developed by D.A. Paramelle (2014, “A Rapid Method to Estimate the Concentration of Citrate Capped Silver Nanoparticles from UV-Visible Light Spectra,” Analyst 139(19): 4855-4861). Briefly, using the measured wavelength absorption maximum and the Table developed by Paramelle, it was predicted that the size of the formed silver nanoparticles would be approximately 20 nm in size. As shown in FIG. 1B, a TEM image later confirmed that the size of the silver on the zein particle was approximately 15 nm. The overall size of the zein particle in solution appeared larger, as shown by the Dynamic light scattering results of the zein-silver particles in FIG. 2B, that appeared to be approximately 200 nm in size.

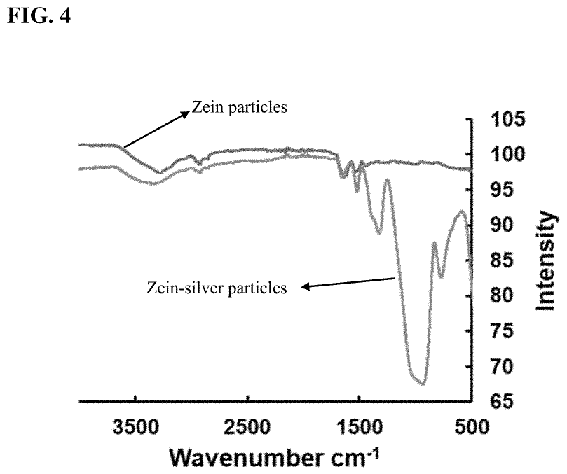

To further characterize the zein particles and the silver nanoparticles, the FTIR spectrum of the zein particles before and after the silver treatment was recorded. The spectrums are shown in FIG. 4, and the bands recorded with the zein particles and with the zein-silver particles are listed in Table 1, below, as are the function groups assigned to each band.

TABLE 1
FTIR Assignments

| Zein Particles | Zein-Ag Particles | |
|---|---|---|
| cm−1 | cm−1 | Function Group |
| 3320 | 3290 | OH |
| 2920 | 2930 | C—H |
| 1650 | 1650 | C═O |
| 1520 | 1490 | Aromatic C═C |
| | 1380 | C—C |
| | 1320 | C—N—Ag |
| | 1020 | C—O—C |
| | 931 | |

After treatment of the zein particles with silver, bands appeared at 1380, 1320, 1020, and 931 cm−1. The bands recorded with the zein particles, and the bands recorded with the zein-silver particles at 1380, and 1320 cm′ are in agreement with literature. However, the new peaks observed at when 1020 cm′, and 931 cm′ have not been reported by others. Not wishing to be bound by theory, these changes may be caused by changes in the polymer added to the reaction of the zein particles with silver. It may be possible that when mixing the zein particles with polyethylene, glycol, and lactic acid.

The information given in this example shows the preparation and characterization of zein particles, and of zein-silver particles.

### Example 2

### Larvicide Activity of Zein-Silver Particles

The larvicidal effect of the zein-silver particles prepared above was tested on Culex quinquefasciatus mosquito species.

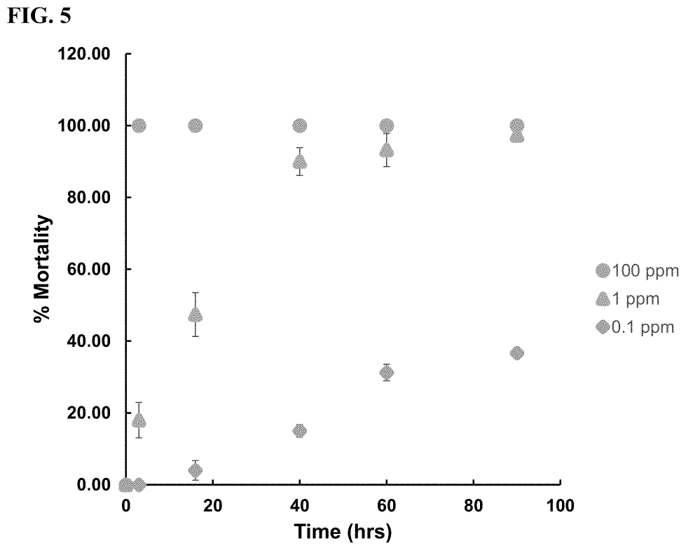

Twenty mosquito larvae were exposed to 0.2 ppm sodium borohydride, 0.2 ppm glycerol, 200 ppm of a 1:1:1 polymer mixture (lactic acid:glycerol: PEG, 200 ppm zein particles, H₂O, or zein-silver particles at 100 ppm, 1 ppm, or 0.1 ppm. The results obtained after 40 hours are shown in FIG. 5, and Table 2, below. The only control that killed larvae was the sodium borohydride, which after 90 hours showed 8% killing. This table shows that zein-silver particles at 100 ppm and at 1 ppm killed approximately 100% of the mosquito larvae.

TABLE 2
MOSQUITO MORTALITY

| Treatment | Larval Mortality (%) |
|---|---|
| 100 ppm zein-silver particles | 100 |
| 1 ppm zein-silver particles | 90 |
| 0.1 ppm zein-silver particles | 15 |
| sodium borohydride | 8 |
| Glycerol | 0 |
| zein particles | 0 |
| Lactic acid/glycerol/PEG | 0 |
| H₂O | 0 |

As seen in FIG. 5, the mosquito larvae died in 4 four hours when using 100 ppm zein-silver particles, and died in 40 hours when using 1 ppm zein-silver particles. Up to the end of the trial (100 hours), only 40% of the mosquito larvae died when using 0.1 ppm zein-silver particles. In the first trail 1 of 20 larvae emerged as adults when using 1 ppm zein-silver particles, and 3 of 20 larvae emerged as adults when using 0.1 ppm zein-silver, while in the last two trials no mosquitoes emerged as adults after two weeks. These results suggest that the zein-silver particles stunted the larvae's development.

The size and shape of the nanoparticles have been shown to play a vital role on the reaction of the particles to the substrate. The UV-visible and the TEM of the zein-silver particles show that silver nanoparticles of approximately 20 nm in size form on the surface of the zein particles. Nanoparticles of around 10 to 20 nm are expected to provide better contact between the cell and particle.

The results obtained in this Example show that zein-silver particles kill mosquito larvae, or at least stunt their development.

### Example 3

### Zein-Silver Particle Mosquito Mortality

To understand the mechanism of larval mortality caused by the zein-silver particles of the invention, mosquito larvae images were recorded.

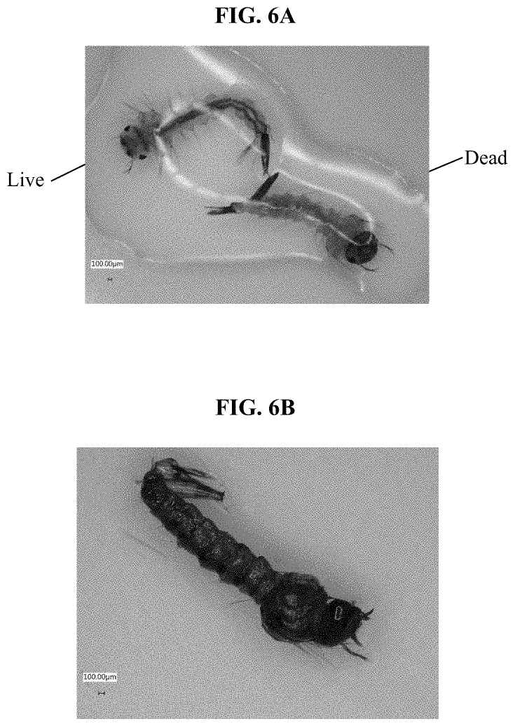

The mosquitos were first examined under an optical microscope, followed by examination by SEM. The image on FIG. 6A shows two mosquitos larvae side by side, a healthy mosquito still moving, and a mosquito killed by 100 ppm zein-silver particles. When taking this picture, the healthy larva was still moving and its gut was still visible, while the larva exposed to the zein-silver particles appeared brown and its gut was no longer visible. The larva exposed to zein-silver particles was no longer transparent and the hairs on it didn't stick out as uniformly as they did on the healthy larva. Most mosquitos exposed to zein-silver particles appeared as the dead mosquito shown on FIG. 6A. The image on FIG. 6B shows another larva exposed to 100 ppm zein-silver particles. This larva appeared totally black, and was taken from the same container as the dead mosquito in FIG. 6A. A few mosquitos exposed to zein-silver particles appeared totally black in color, but they were a minority of the total population. Not wishing to be bound by theory, it is believed that the gut in the dead mosquito in FIG. 6A is not visible because the cells in and around the gut were discolored by the silver.

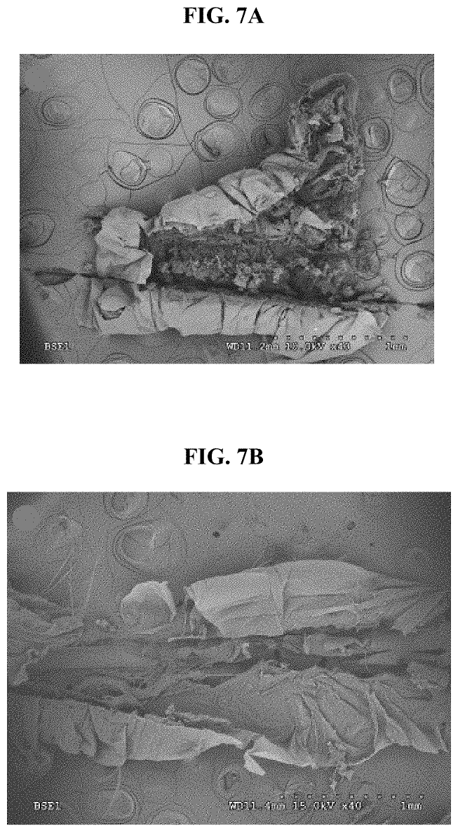

To visualize the effect of silver on the mosquito larvae abdomen, SEM images were obtained from abdomens of a mosquito larva not exposed to silver nanoparticles and a mosquito larva exposed to 100 ppm zein-silver particles. As can be seen in FIG. 7A, the mosquito larva exposed to water showed a gut with bacteria still inside. However, as seen in FIG. 7B, the mosquito exposed to 100 ppm zein-silver particles showed a gut that was hollow.

To determine the chemical analysis of the features observed in the SEM, Energy Dispersive Spectroscopy (EDAX) was run on the healthy larva followed by exposing the larva to zein-silver particles. The data obtained by EDAX is shown in Table 3, below.

TABLE 3
EDAX Results

| Larva Exposed to Water | | Larva Exposed to Zein-Silver Particles | |
|---|---|---|---|
| Element | Weight % | Element | Weight % |
| C | 58.35 | C K | 59.32 |
| O | 16.83 | O | 28.66 |
| Na | 0.83 | Na | 0 |
| S | 2.96 | S | 0 |
| Ca | 1.99 | Ca | 9.63 |
| P | 19.04 | P | 0 |
| Ag | 0 | Ag | 2.39 |
| Total | 100 | Total | 100 |

As can be seen in Table 3 above, after exposure to the zein-silver particles, the mosquito larva showed an EDAX peak for silver, while no EDAX peak for silver was detected prior to exposure to the zein-silver particles. The EDAX of the larva not exposed to zein-silver particles showed a phosphorous peak and sulfur peak, while the EDAX of the larva exposed to zein-silver particles did not show these peaks. The absence of the phosphorous peak and sulfur peak in the EDAX of the larva exposed to zein-silver particles suggests that the silver may have attacked the sulfhydryl groups of the respiratory system and the phosphorous in the ATP. The larva exposed to zein-silver particles did not show a sodium peak, and showed a calcium peak that was increased by four times. As expected, a silver peak of 2.3% was seen on the larva exposed to zein-silver particles. These results suggest that silver nanoparticles were in the gut of the treated mosquito larva.

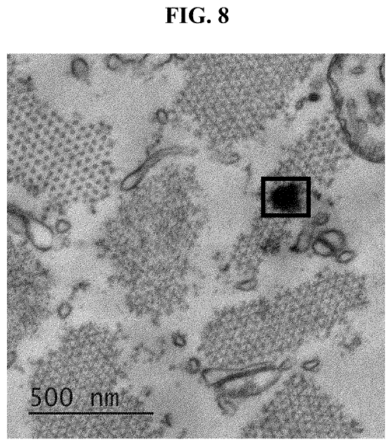

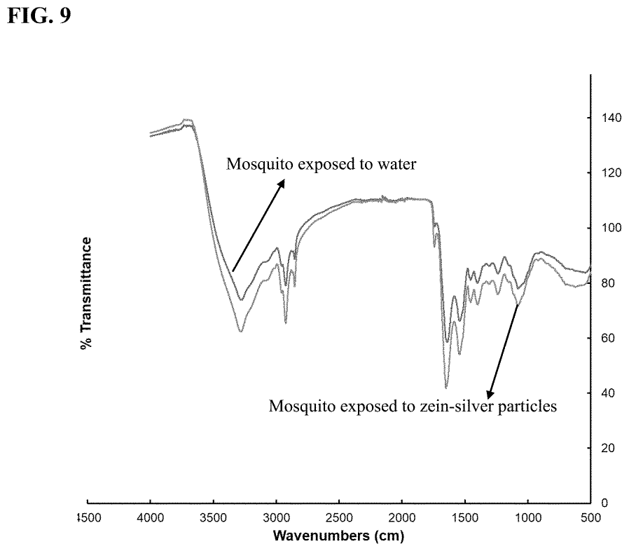

To determine the presence of silver in the gut of treated larvae, a transverse tissue section of the gut of a mosquito exposed to 1 ppm zein-silver particles was observed using TEM. As seen on FIG. 8, the TEM images showed silver nanoparticles in the tissue. An FTIR was recorded on a healthy mosquito larva and a mosquito larva that was exposed to 100 ppm silver-zein particle solution. As seen in FIG. 9, no difference in the FTIR spectrum was observed between the two. This suggest that the exposure to silver causes a change inside the mosquito larva.

The results obtained in this Example show that the biodegradable particles in contact with an active ingredient are ingested by mosquito larvae, and cause changes in the larva's digestive tract.

We claim:

1. A composition comprising at least one biodegradable particle prepared from a grain, optionally comprising at least one active ingredient, and optionally comprising a protecting coating.

2. The composition of claim 1, wherein the biodegradable microparticle comprises a natural nutrient source for a target arthropod and/or a target plant and/or a target mammal.

3. The composition of claim 2, wherein the biodegradable particle that comprises a natural nutrient source for a target arthropod and/or a target plant and/or a target mammal is derived from a grain.

4. The composition of claim 3, wherein the grain is wheat, sorghum, maize, rice, coffee, oats, soybean, or alfalfa.

5. The composition of claim 4, wherein the natural nutrient source for a target insect is corn zein, wheat starch, wheat gluten, wheat bran, sorghum starch, sorghum gluten, sorghum bran, or sorghum high phenolic bran, or sorghum kafirin.

6. The composition of claim 1, wherein the composition comprises at least one active ingredient inside the particle, blended with the particle, or coating the particle.

7. The composition of claim 6, wherein the active ingredient is at least one of a pesticide, a dye, an arthropod attractant, an arthropod repellent, an arthropod nutrition supplement, an enhancer of arthropod pest resistance, or an enhancer of plant arthropod resistance.

8. The composition of claim 7, wherein the active ingredient is at least one of silver, gold, curcumin, Bacillus thuringiensis, Methoprene, Spinosad, trehalose, or proline.

9. The composition of claim 1, wherein the composition further comprises a protective coating.

10. The composition of claim 9, wherein the protective coating is a polymer, a hydrogel, a surfactant, or a reactive coating.

11. The composition of claim 10, wherein the reactive coating is a temperature responsive coating, a pH responsive coating, or a UV-visible responsive.

12. A method for preparing biodegradable particles of claim 1, the method comprising:
adding lactic acid, polyethylene, and glycerol to glacial acetic acid;
stirring in a grain or part thereof;
stirring and heating at an appropriate temperature and for a sufficient amount of time to obtain particles;
removing the supernatant; and
washing the microparticles with water.

13. A method for preparing biodegradable microparticles with silver or gold nanoparticles, the method comprising:
slowly adding a solution containing biodegradable microparticles to a silver or gold-nanoparticle-precursor solution in water to create a mixture,
heating and stirring the mixture for a sufficient amount of time and at a sufficient temperature to dissolve the microparticles, and
adding sodium borohydride solution until the solution turns brown,
to prepare biodegradable microparticles with silver or gold nanoparticles.

14. The composition of claim 10, wherein the reactive coating is a temperature responsive coating, a pH responsive coating, or a UV-visible responsive coating.

15. A method for causing mortality or stunting development of an adult or immature arthropod, the method comprising contacting said arthropod with at least one composition of claim 1.

16. The method of claim 15, wherein the adult or immature arthropod is a common pest of medical, veterinary, agricultural, or urban importance.

17. The method of claim 16, wherein the adult or immature arthropod is a mosquito, a house fly, an ant, a biting midge, a bee parasite, a red flour beetle, a mite, a tick, or a wasp.

18. A method to enhance arthropod pest resistance, the method comprising contacting said arthropod with at least one composition of claim 7, comprising an enhancer of arthropod pest resistance.

19. The composition of claim 1, wherein the biodegradable particle is an essential plant nutrient, and the active ingredient is a pesticide for arthropods feeding on the target plant.

20. The composition of claim 19, wherein the active ingredient is nitrogen, phosphorus, potassium, iron, boron, chlorine, manganese, zinc, molybdenum, or nickel.

21. The composition of claim 20, wherein the active ingredient is nitrogen, phosphorus, and potassium present in equal parts, or wherein the active ingredient is nitrogen, phosphorus, and potassium, wherein potassium and nitrogen are present in a higher amount than phosphorus.
